(19) United States
(12) Patent Application Publication
(10) Pub. No.: US 2017/0336008 A1
(43) Pub. Date: Nov. 23, 2017

(54) TUBING AND JUNCTION ASSEMBLY AND METHOD OF MAKING THE SAME

(71) Applicant: Q HOLDING COMPANY, Twinsburg, OH (US)

(72) Inventors: Steven E. Hankins, West Milwaukee, WI (US); Todd R. Schuh, Racine, WI (US)

(73) Assignee: Q HOLDING COMPANY, Twinsburg, OH (US)

(21) Appl. No.: 15/592,419

(22) Filed: May 11, 2017

Related U.S. Application Data
(60) Provisional application No. 62/337,452, filed on May 17, 2016.

(51) Int. Cl. F16L 41/02

(52) U.S. Cl. CPC F16L 41/021

(57) ABSTRACT

A tubing and junction assembly and method of making the same are disclosed. The assembly includes a shell having a bore extending from a first opening to a second opening, and a third opening extending from an exterior surface of the shell to a first end portion of the bore. A tubing is seated within the bore. A bonding agent is disposed between the tubing and the shell. The method of making the tubing and junction assembly includes forming or providing a shell, inserting an end of the tubing through the first opening into the shell, inserting a bonding agent through the third opening of the shell into a gap between the tubing and the shell, and curing the bonding agent to join the tubing to the shell.

### CROSS-REFERENCE TO RELATED APPLICATIONS

This application claims the benefit of U.S. Provisional Application No. 62/337,452 filed May 17, 2016, and incorporated herein by reference in its entirety.

### FIELD

A device and method of making a device for transporting fluid are generally described. In particular, a tubing and junction assembly for distributing a fluid, and a method of making the tubing and junction assembly, are described.

### BACKGROUND

Tubing assemblies utilizing connectors and tubing have long been used in various industries, such as the medical industry, automotive industry and aerospace industry. For example, in the medical industry, tubing assemblies have been used in connection with various healthcare and pharmaceutical applications, for example, to transfer fluids to or from the human body, and in some circumstances, directly within the human body. Examples of such medical devices may include intravenous catheters connected to feeding pumps, tubes connected to hemodialysis equipment, medical devices that use peristaltic pumps, fittings and/or couplers connected to gastronomy tubes, and any other medical assemblies that introduce fluids through supply tubing and various flexible-tube sections.

In any and all of such industries and uses, tubing assemblies are typically closed systems that are fully sealed to prevent leakage of fluids being transported and/or to prevent contaminants from entering the system. Special connectors may be used to connect various lengths and/or types of tubing together, and to connect tubing to devices (e.g., medical devices or otherwise), to prevent contamination of the system and/or prevent leakage of fluids from the system, such as at the point of connection or sealing.

Some conventional tubing assemblies include tubes that are entirely encapsulated into a shaped connector. One disadvantage with this type of assembly is that it is usually cumbersome, and requires multiple steps for assembly, which can be costly for manufacturers and end users. Other conventional tubing assemblies require manual connection of the tubing to connectors through use of a bonding agent, for example, a one-part or two-part adhesive. A disadvantage of this type of assembly is that gaps and/or voids may be created between the tubing and the connectors, which can lead to contamination and/or leakage of the fluid being transported. Another conventional technique for forming such assemblies involves the use of an over molding process, in which multiple molding steps are used to form an integral tubing and connector assembly. A disadvantage of this process is that it may be complicated, and requires the use of multiple components and multiple steps to create the connector and tubing assembly.

Recent trends in the medical industry dictate that suppliers need to be cost-effective and reduce the number of materials being used in connector and/or tubing and junction assemblies, which can be difficult using the aforementioned techniques. Accordingly, there is a need for a tubing and junction assembly that provides an airtight connection between lengths of tubing and increased adhesion between the tubing and junction. Further, there is a need for a process of making a tubing and junction assembly that is relatively easy and cost-effective to implement.

### BRIEF DESCRIPTION

In one aspect, the present application is directed to a method of making a tubing and junction assembly for distributing a fluid. The method may include forming a junction body or shell (using injection molding or other suitable molding technique), where the shell has a first opening, a second opening, and a third opening. An end of a tubing may be inserted through the first opening into the bore so that the end of the tubing is fittably seated within the bore. A bonding agent may then be introduced through the third opening of the shell to fill a gap between the tubing and shell. The bonding agent may then be cured so that the bonding agent joins the tubing to the shell.

In another aspect, the present application is directed to a tubing and junction assembly for transporting or distributing a fluid. The tubing and junction assembly may include a junction body or shell (formed using injection molding or any other suitable molding technique) having a first opening positioned along a first end of a bore, a second opening positioned along a second end of a bore, and a third opening extending inwardly from an exterior surface of the shell to the bore. The bore may extend from the first opening to the second opening, and may include a first end portion including the first end of the bore, a second end portion including the second end of the bore, and a medial portion extending between the first end portion and the second end portion of the bore. Tubing having an end, an outer diameter, an inner diameter, and a lumen defined by the inner diameter may be fittably seated within the bore. For example, the end of the tubing may be positioned within the medial portion of the bore, such that the end of the tubing is adjacent to the second end portion of the bore. More particularly, the inner diameter of the tubing may be approximately equal to the diameter of the second end portion of the bore, so that the lumen is in open communication with the second end portion of the bore, and the outer diameter of the tubing may be approximately equal to the diameter of the medial portion of the bore, so that the end of the tubing is fittably seated within the medial portion of the bore. The outer diameter of the tubing may be less than the diameter of the first end portion of the bore, thereby defining a space between an outer surface of the tubing and an interior surface of the shell along the first end portion of the bore for receiving an uncured bonding agent during assembly, and ultimately defining the space occupied by the cured bonding agent. Additionally, the cured bonding agent may extend outwardly from the bore along the first opening to provide an additional seal (i.e., seal bead) on the exterior of the shell. By forming the sealed areas in this manner, the resulting tubing and junction assembly provides superior resistance to leakage and/or contamination as compared with conventional assemblies.

### BRIEF DESCRIPTION OF THE FIGURES

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1 is a perspective view of an exemplary tubing and junction assembly, according to one aspect of the disclosure;

FIG. 2 is a cross-sectional view of the tubing and junction assembly of FIG. 1;

FIGS. 3A-3C are perspective views of the tubing and junction assembly of FIG. 1, illustrating an exemplary method of assembly;

FIGS. 4A-4C are top views of the tubing and junction assembly of FIGS. 3A-3C;

FIGS. 5A-5C are front views of the tubing and junction assembly of FIGS. 3A-3C;

FIG. 6 is a perspective view of an exemplary tubing and junction assembly having a T-shape, according to an embodiment;

FIG. 7 is a cross-sectional view of the tubing and junction assembly of FIG. 6; and

FIG. 8 is a cross-sectional view of the tubing and junction assembly of FIG. 6, illustrating a flow groove.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DETAILED DESCRIPTION

This disclosure generally relates to a tubing and junction assembly for distributing a fluid, and a method of making the tubing and junction assembly.

Although the tubing and junction assemblies of this disclosure may have widespread utility for a number of applications, such devices may have particular utility in the healthcare and pharmaceutical industries, in which adequate sealing of tubing assemblies is imperative to reduce the potential for contamination. The present tubing and junction assembly addresses this need because the tubing and junction are bonded both on the interior and the exterior of the junction assembly. Specifically, a first bond is formed between the tubing and junction within the body of the junction itself, and a second bond extends from the first bond to an exterior of the junction to define a seal along an exterior surface of the junction. By forming the tubing and junction assembly in this manner, the potential for leakage and or contamination is significantly reduced.

Generally described, the tubing and junction assembly contemplated hereby includes a junction body or shell (formed via injection molding or otherwise), a tubing, and a cured bonding agent. As described above, the cured bonding agent lies both within the tubing and junction assembly and along the exterior of the shell at the point of connection between the tubing and the shell.

Viewed in isolation, the junction body or shell may generally include a first opening, a second opening and a third opening, where the first opening and the second opening may be considered major or primary openings, and the third opening may be considered a minor or secondary opening. The first opening may include and/or be defined by a first end of a bore, the second opening may include and/or be defined by a second end of the bore, and the bore may extend along a lengthwise dimension of the shell.

The bore may generally be described as including a number of sections or portions, for example, a first end portion that includes and/or is adjacent to the first end of the bore, a second end portion that includes and/or is adjacent to the second end of the bore, and a medial portion positioned between the first end portion and the second end portion of the bore.

In the completed assembly, the tubing may be positioned within the first end portion of the bore and the medial portion of the bore, for example, such that an end of the tubing lies within the medial portion of the bore. The tubing and shell may be dimensioned so that, when the tubing is inserted into the bore, a gap is defined between the tubing and the interior surface of the shell. During assembly, the gap is then filled by a bonding agent, which is subsequently cured to form a bond/seal between the tubing and the shell.

As stated above, the shell may also include a third opening that may extend from an exterior surface of the shell into the first end portion of the bore. The third opening of the molded shell may generally serve as an access point for introducing the bonding agent into the interior of the shell, and therefore, may be thought of as an injection port for supplying the bonding agent to the bore of the shell. Additional openings or access points may be provided, depending on the needs of the particular application.

Generally described, a method of making the tubing and junction assembly described above includes providing and/or forming the shell, and inserting the end of the tubing through the first opening of the bore, so that the end of the tubing is seated within the medial portion of the bore. As stated previously, the tubing and shell are dimensioned so that an outer diameter of the tubing is generally less than a diameter of the first end portion of the bore, thereby defining a gap between the outer surface of the tubing and the interior surface of the shell. A sufficient amount of bonding agent may be introduced into this gap through the third opening to fill the gap and be urged outwardly along the first end of the bore. The bonding agent may then be cured to join the tubing to the shell and form an exterior seal bead.

Reference will now be made in detail to various exemplary embodiments. Each example is provided by way of explanation, not limitation, and does not constitute a definition of all possible embodiments.

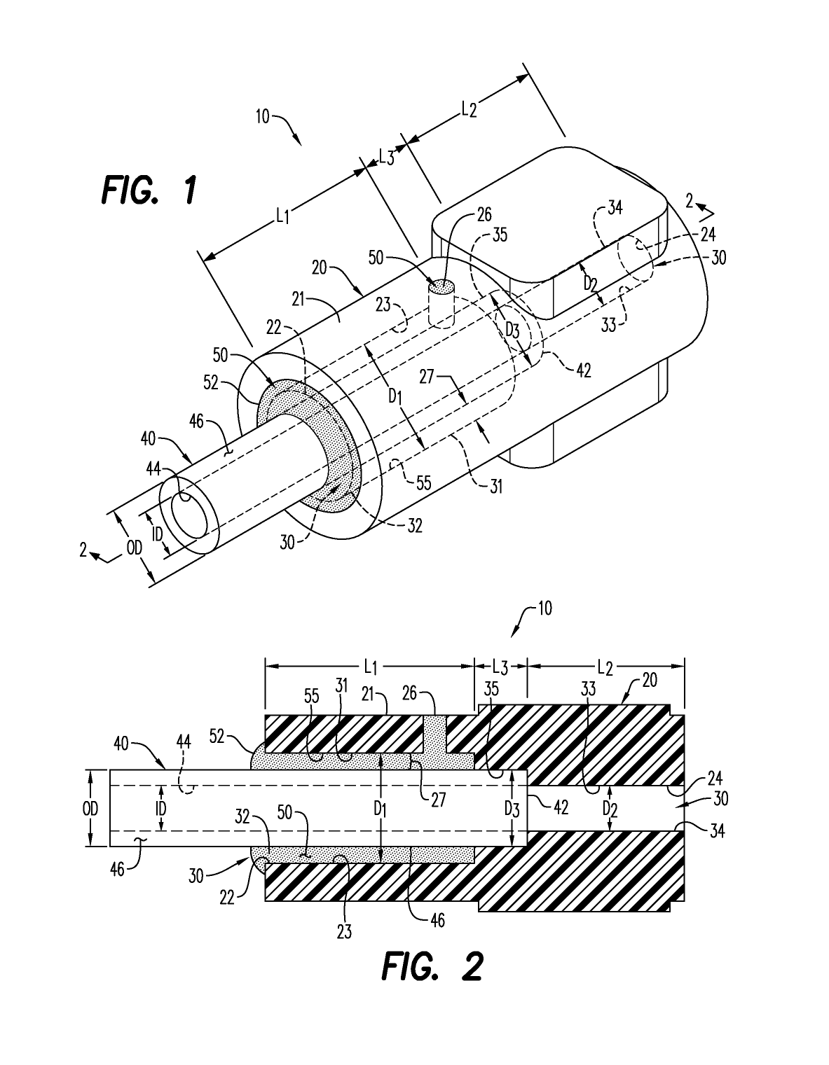

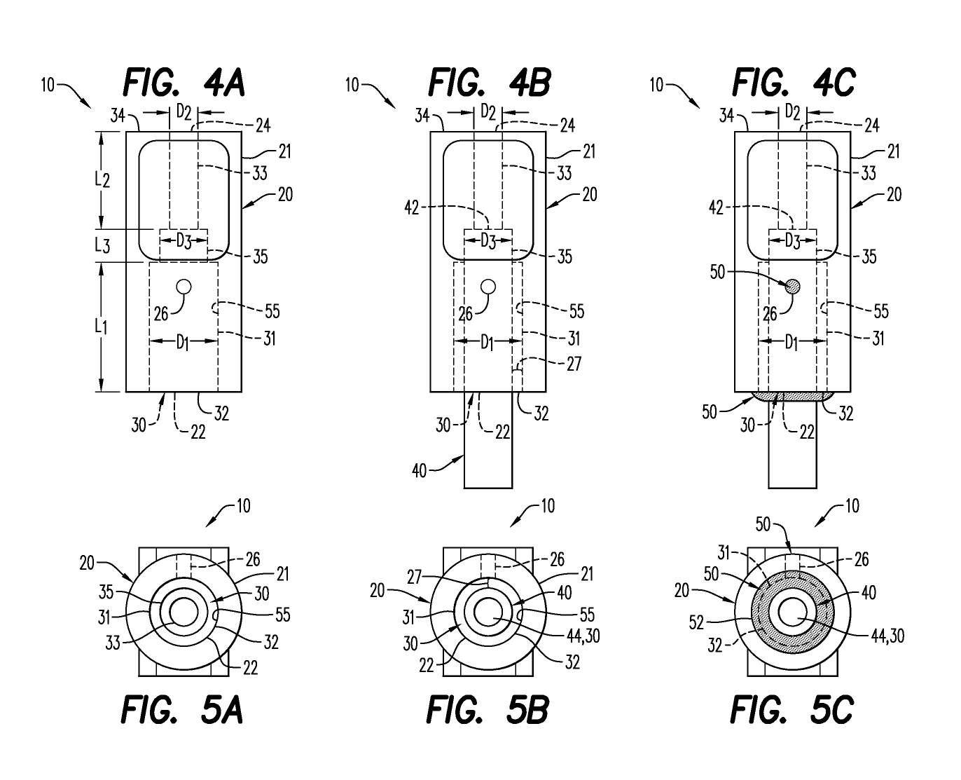

FIGS. 1-5 generally illustrate a tubing and junction assembly 10 having a junction body or a shell 20, a tubing 40 for transporting a liquid, and a bonding agent 50 for joining the tubing 40 to the shell 20. Specifically, FIGS. 1-5 schematically illustrate the tubing and junction assembly 10, configured for distributing a fluid (or fluid-like material). The tubing and junction assembly 10 includes the junction body or shell 20, which may be formed using injection molding or any other suitable molding or formation technique. As illustrated in FIGS. 1-5, the shell 20 may include a first opening 22 and a second opening 24, which may generally serve as primary connection points between the tubing, shell, and other components to which the junction assembly may be connected. The shell 20 may include a bore 30 extending along a lengthwise dimension (e.g., length) of the shell 20, such that the first opening 22 may include and/or be defined by a first end 32 of the bore 30, and the second opening 24 may include and/or be defined by a second end 34 of the bore 30. The bore 30 extends from the first opening 22 to the second opening 24, such that it forms or defines an open channel that traverses the entire lengthwise dimension of the shell 20 (best seen in FIGS. 2 and 5A-5C.) Thus, the bore 30 provides a passageway or region for receiving the tubing 40 and the bonding agent 50/cured bonding agent 50, as will be discussed further below.

As illustrated in FIGS. 1-5, the bore 30 may generally be thought of as including several sections or portions. It will be appreciated that the boundary between such sections or portions may be difficult to precisely define. Nonetheless, for the purposes of explanation and not limitation, the bore 30 may be generally described as including a first end portion 31, a second end portion 33, and a medial portion 35. The first end portion 31 may include and/or be adjacent to the first end 32 of the bore 30, the second end portion 33 may include and/or be adjacent to the second end 34 of the bore 30, and the medial portion 35 may generally extend or lie between the first end portion 31 and the second end portion 33 of the bore 30.

The first end portion 31, the second end portion 33, and the medial portion 35 may each be characterized as having a respective length L1, L2, L3 extending in a lengthwise direction, such that the sum of the lengths L1, L2, L3 may substantially equal the length of the bore. The respective lengths L1, L2, L3 of each of the first end portion 31, the second end portion 33, and the medial portion 35 may be selected based on the needs of the particular application for which the tubing and junction assembly 10 is being used. For example, in the exemplary embodiment illustrated in FIGS. 1-2, the length L1 of the first end portion 31 is generally greater than at least one of the length L2 of the second end portion 33 and the length L3 of the medial portion 35, the length L2 of the second end portion 33 is generally greater than the length of the medial portion 35, and the length L3 of the medial portion 35 is generally greater than at least one of the length L1 of the first end portion 31 and the length L2 of the second end portion 33. However countless other possibilities are contemplated, as will be appreciated by those of skill in the art.

As illustrated in FIGS. 1-2, the first end portion 31, the second end portion 33, and the medial portion 35 of the bore 30 may likewise each have a respective diameter D1, D2, D3. As will be discussed further below, the diameter D1 of the first end portion 31 may generally be greater than an outside diameter of the tubing 40, so that the tubing 40 can be received within the first end portion 31 of the bore, and provide a space or gap between the tubing 40 and interior surface of the shell 20 for receiving the bonding agent 50. At the same time, the diameter D3 of the medial portion 35 may be less than the diameter D1 of the first end portion 31, and may be approximately equal to or slightly greater than the outside diameter OD of the tubing 40, so that an end of the tubing 40 may be compressively seated within the medial portion 35 of the bore 30. Finally, the diameter D3 of the medial portion 35 may generally be greater than the diameter D2 of the second end portion 33, and an inner diameter ID of the tubing 40 may be approximately equal to the diameter D2 of the second end portion 33.

It will be noted that in the illustrated embodiment, the respective diameters D1, D2, D3 of the first end portion 31, the second end portion 33, and the medial portion 35 of the bore 30 are each substantially uniform along their respective lengths L1, L2, L3 (i.e., each has a constant diameter along the length of the respective section), such that the first end portion 31, the medial portion 35, and the second end portion 33 of the bore 30 may have a substantially stair-stepped cross-sectional profile as viewed along the length of bore 30. However, other possibilities are contemplated.

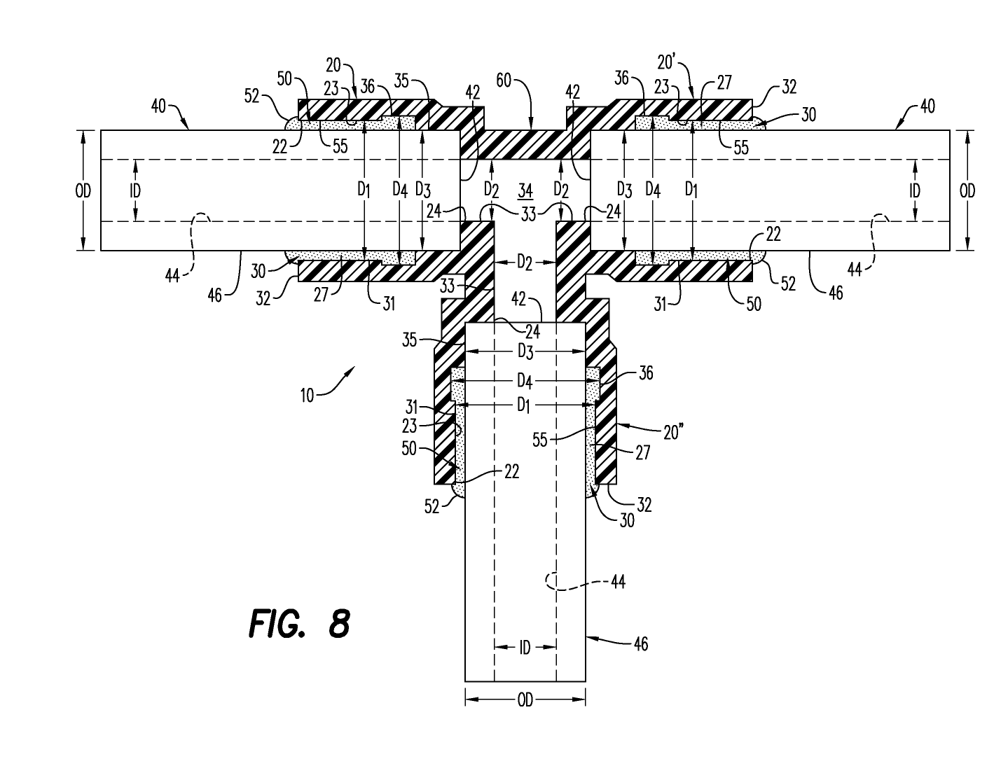

In some embodiments, for example, as shown in FIG. 8, the bore 30 may also include a transitional portion or flow groove 36 positioned between the medial portion 35 and the first end portion 31 of the bore 30. As with the various other portions of the bore 30, the flow groove 36 has a length L4 and a diameter D4 that may be selected based on the needs of the particular application. In general, the diameter D4 of the flow groove 36 may be greater than the diameter D1 of the first end portion 31, and also may be greater than the diameter D2 of the medial portion 35, such that the flow groove 36 defines an expanded area within the bore 30.

The inclusion of a flow groove 36 may provide significant benefits in forming the tubing and junction assembly. For example, the presence of a flow groove 36 may help to improve air removal, such as, for example, air bubbles that may be trapped between the interior surface 23 of the shell 20 and the outer surface 46 of the tubing 40. Specifically, and while not wishing to be bound by theory, it is believed that when the bonding agent 50 is inserted into the bore 30, the flow groove 36 provides an increased space within the bore 30 to receive the bonding agent 50. This increased space may serve as a conduit that is filled with the bonding agent 50 before the first end portion 31 of the bore 30 is filled with the bonding agent 50, thereby improving the effectiveness of air removal and ensuring a solid seal within the bore 30. This may also help to improve the adhesion of the tubing 40 to the shell 20, and eliminate any gaps that can capture and retain any fluids being distributed by the tubing and junction assembly 10.

Returning to FIGS. 1-5, the shell 20 includes a third opening 26, which may generally be considered a minor opening relative to the first opening 22 and the second opening 24. In the embodiments shown in FIGS. 1-4, the third opening 26 may extend from the exterior surface 21 of the shell 20 to the first end portion 31 of the bore 30, so that the exterior surface 21 of the shell 20 is in open communication with the bore 30, in this example, the first end portion 31 of the bore 30. Alternatively, in embodiments having the flow groove 36, the third opening 26 may be positioned along the flow groove 36, so that the exterior surface 21 of the shell 20 is in open communication with the flow groove 36 of the bore (FIG. 8).

The third opening 26 may define and/or serve as a conduit to receive and transmit the bonding agent 50 to the bore 30, and therefore may be referred to as an injection opening or injection port. When a sufficient quantity of a bonding agent 50 is introduced through the third opening 26, the bonding agent 50 may fully encompass (i.e., fill) both the third opening 26 and any available space along the first end portion 31 (and within the flow groove 36, where present) of the bore 30. In other words, the bonding agent 50 may be positioned in the third opening 26, and between the outer surface 46 of the tubing 40 and the interior surface 23 of the shell 20 along the first end portion 31 (and the flow groove 36, where present) of the bore 30. In this way, the bonding agent 50 may sealably close (i.e., seal) the third opening 26, such that the exterior surface 21 of the shell 20 is no longer in open communication with the first end portion 31 (or the flow groove 36, where present) of the bore 30.

As illustrated in FIGS. 1, 2, and 5, the third opening 26 may be perpendicular to the bore 30, that is, the third opening 26 may be positioned at a substantially 90-degree angle from the bore 30. However, other configurations are contemplated. Additionally, while the use of one third opening 26 is described hereinabove, it is envisioned that 2, 3, 4, 5, or more of such openings 26 may be included in the shell 20, based on the needs of the application.

Countless embodiments and variations of the shell 20 are contemplated hereby. For example, the shell 20 may be formed (e.g., molded) as a single piece, or in some embodiments, may be formed as multiple pieces that are joined to one another to form the shell 20. The shell 20 may have any desired shape, size and/or dimensions, as needed to suit the needs of any application for which it is being made. For example, the molded shell 20 and/or the tubing and junction assembly 10 may have a linear shape, as shown for example, in FIGS. 1-5, a T-shape, as shown for example, in FIGS. 5-8, or may have any other desired shape.

The shell 20 may be formed from any suitable material, including materials that may be considered rigid, semi-rigid, or flexible, provided that the material is sufficiently robust to withstand the conditions under which the shell is bonded to the tubing, and provided that the material is ultimately suitable for the particular application. For instance, in some embodiments, the shell may be formed from a metallic material (e.g., a metal), a polymeric material (e.g., a polymer), or any combination thereof. One specific example of a polymeric material that may be suitable for a variety of applications including, but not limited to, medical applications, is a silicone-based polymer. Silicone-based polymers that may be suitable include high consistency silicone rubber (HCR), liquid silicone rubber (LSR), or any combination thereof.

The shell 20 may be opaque, translucent, or transparent, and may be colored or colorless, as desired, as will be discussed further below.

As referenced above, the assembled tubing and junction assembly 10 may also include a tubing 40. As illustrated in FIGS. 1-2, 3B-3C, 4B-4C and 6-8, the tubing 40 may generally include an end 42, an outer diameter OD, and an inner diameter ID. The tubing 40 may include a lumen 44 (i.e., channel or duct) defined by the inner diameter ID. The end 42 of the tubing 40 may be positioned within the medial portion 35 of the bore 30, such that the end 42 of the tubing 40 may be adjacent to the second end portion 33 of the bore 30.

As described previously, the inner diameter ID of the tubing 40 may be approximately equal to the diameter D2 of the second end portion 33 of the bore 30, so that the lumen 44 is in open communication with the second end portion 33 of the bore 30. The outer diameter OD of the tubing 40 may be less than the diameter D1 of the first end portion 31 of the bore 30 to provide ample space for receiving the bonding agent 50. The outer diameter OD of the tubing 40 may be approximately equal to the diameter D2 of the medial portion 35 of the bore 30, so that the end 42 of the tubing 40 is fittably seated within the medial portion 35 of the bore 30 (e.g., the end 42 of the tubing 40 is retained within the medial portion 35 by an interference or friction fit). This configuration helps to facilitate proper positioning of the tubing 40 into the bore 30 for alignment of the inner diameter ID of the tubing 40 with the diameter D2 of the second end portion 33, as well as proper positioning for the cured bonding agent 50 between the outer surface 46 of the tubing 40 and the interior surface 23 of the shell 20.

The tubing 40 may be formed from any material that is appropriate to the application the tubing and junction assembly 10 is being used for. The tubing 40 may be selected based on, for example, its ability to be cut to a desired length, conform to a desired shape, withstand exposure to high temperatures, and/or transport various fluids. For example, in medical applications, the tubing 40 may be formed from a silicone-based polymer, such as those described above.

The tubing and junction assembly 10 further includes a cured bonding agent 50 positioned between the outer surface 46 of the tubing 40 and the interior surface 23 of the shell 20, along the first end portion 31 of the bore 30. The cured bonding agent 50 may also extend into the third opening 26 of the shell 20, thereby closing the third opening 26 and preventing communication between the exterior surface 21 of the shell 20 and the first end portion 31 of the bore 30. Additionally, the cured bonding agent 50 may extend outwardly from the first opening 22 of the junction, thereby defining a seal bead 52 along and around the first opening 22 of the shell 20, where the tubing 40, shell 20, and the cured bonding agent 50 meet. By providing these additional sealed areas 50, 52, an airtight connection is created between the outer surface 46 of the tubing 40 and the interior surface 23 of the shell 20, thereby protecting against fluid leakage and/or penetration, which in turn, may prevent contamination of the assembly 10 and/or prevent leakage of fluids from the assembly 10.

The cured bonding agent 50 and seal bead 52 may comprise any suitable material, for example, a silicone-based polymer such as those described above.

The cured bonding agent 50 may include a color that differs from a respective color of the tubing 40 and shell 20, thereby helping to facilitate ease of application and ease of identification of bonded surfaces, bond quality and/or bond uniformity around the outer diameter OD of the tubing 40 and the interior surface 21 of the shell 20.

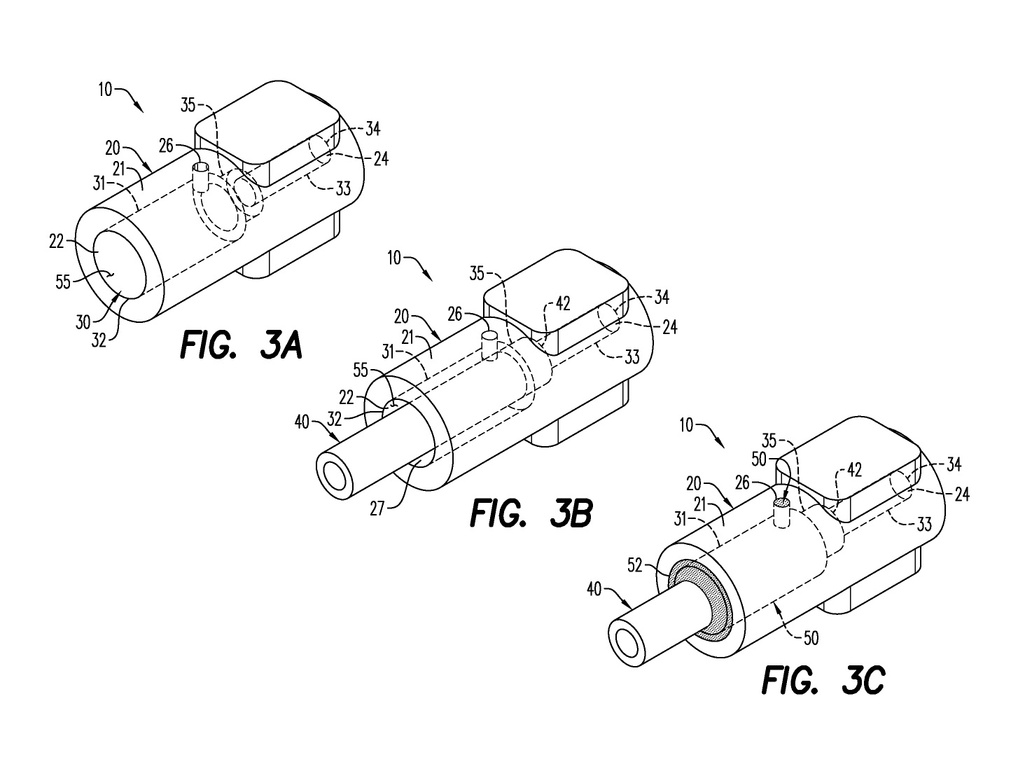

In some embodiments, such as illustrated in FIGS. 3A-3C, a primer layer 55 may be positioned between the interior surface 23 of the shell 20 and the cured bonding agent 50. The primer layer 55 may be provided to enhance a bond between the cured bonding agent 50 and the interior surface 23 of the shell 20. Additionally or alternatively, the shell 20 may have an abraded interior surface 23 configured to increase adhesion of the cured bonding agent 50 to the interior surface 23 of the shell.

It will be appreciated that, although some exemplary embodiments are illustrated and discussed herein, numerous other possibilities are contemplated. Furthermore, various types of tubing and molded shells may be used in combination to form a variety of different tubing and junction assemblies, thereby providing a customized solution for countless applications.

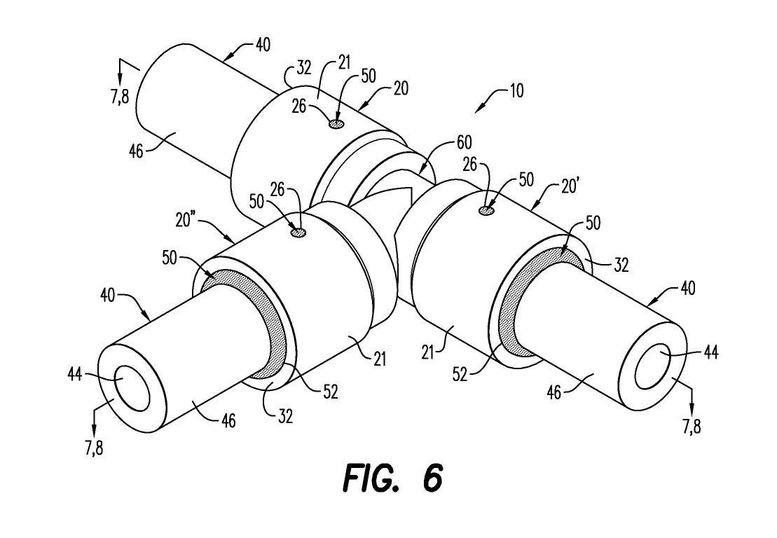

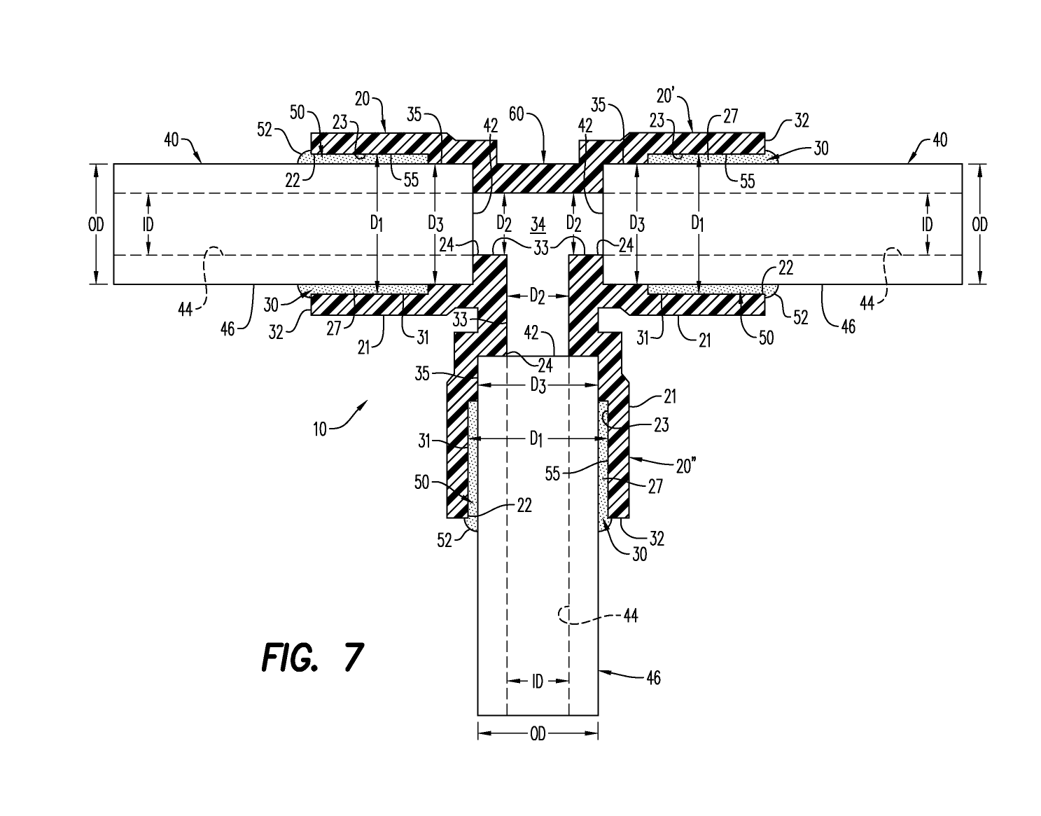

For example, as illustrated in FIGS. 6-8, a plurality of shells may be connected to one another. As shown in the exemplary embodiment, the tubing and junction assembly 10 includes a first shell 20, a second shell 20′ and a third shell 20″. In this example and as illustrated in FIGS. 7-8, the second shell 20′ and the third shell 20″ each include a respective first opening 22, a respective second opening 24, and a respective third opening 26. The first shell 20, the second shell 20′ and the third shell 20″ may each be connected at or along their respective second openings 22. In an embodiment, the tubing and junction assembly 10 includes a connector 60 that connects the first shell 20, the second shell 20′, and the third shell 20″ to each another along their respective second openings 24. In this configuration, the first shell 20, the second shell 20′ and third shell 20″ are arranged so that when the tubing 40, described below, is positioned at each of their respective first openings 22, fluid flow can be split or divided as the fluid moves from one shell to at least one of the second shell 20′ and the third shell 20″. For instance, the first shell 20 may be configured to receive fluid and provide two exit conduits to the second shell 20′ and the third shell 20″, thereby reducing the amount and/or pressure of fluid provided at the first opening 22 of the first shell 20.

Still other possibilities are contemplated. For example, while each of the first, second and third shells 20, 20′, 20″ are illustrated as being substantially identical, it is to be understood that each shell 20, 20′, 20″ may be dimensioned based on the desired application. In an embodiment, the respective diameters D1, D2, D3 of the first end portion 31, the second end portion 33, and the medial portion 35 of each of the first, second and third shells 20, 20′, 20″ may be substantially identical. According to another aspect, the diameters D1, D2, D3 of the first end portion 31, the second end portion 33, and the medial portion 35 of the first shell 20 differs from the respective diameters D1, D2, D3 of at least one of the second and third shells 20′, 20″. The shells 20, 20′, 20″may be arranged such that they form any desired overall shape, such as, for example, the Y, T and X shapes described hereinabove. Additionally, more than three shells may be provided, and may have any desired configuration.

The present disclosure also contemplates a method of making a tubing and junction assembly 10 for distributing a fluid (or fluid-like material). The method may include forming (or otherwise providing) a junction body or shell 20. In one example, the shell 20 may be formed using an injection molding process. In such an example, the shell 20 may be formed by placing/injecting a polymer (for example, a silicone polymer) into a mold and curing the polymer so that the resulting cured polymer has the desired shape of the shell 20 for example, X-shape, a Y-shape, a T-shape, and a straight/linear shape, or any other suitable shape.

The resulting shell 20 may include the various features described above including, but not limited to, a first opening 22, a second opening 24 and a third opening 26, and so on.

As discussed above, the particular material used to form the shell 20 depends on the particular application. In various examples, the shell 20 may comprise a metallic material, a polymeric material, or any combination thereof In one specific example the shell 20 comprises a silicone polymer, such as LSR or HCR, as discussed above.

After the shell 20 is formed (or simply provided), an end of a tubing 40 may be inserted through the first opening 22 into a bore 30 extending between the first opening 22 and the second opening 24, so that the end 42 of the tubing 40 is seated within a medial portion 35 of the bore 30. As discussed above, the tubing 40 and the medial portion 35 of the bore 30 may be dimensioned so that the end 42 of the tubing 40 may be compressively or fittably seated within the medial portion 35 of the bore.

The tubing 40 may be formed from any material that is suitable for the needs of the application, as discussed above. For example, the tubing 40 may include a silicone polymer, such as HCR. According to an aspect, the tubing 40 is cut to an appropriate length, as necessary for its function within the assembly 10.

The method further includes introducing a bonding agent 50 through the opening 26, so that the bonding agent 50 is introduced into a gap 27 formed between the tubing 40 and an interior surface 23 of the shell 20, and curing the bonding agent 50. The introducing and curing of the bonding agent 50 joins/couples/undermolds the tubing 40 to the shell 20, such that no gaps and/or voids exist between the tubing 40 and the shell 20. An excess amount of the bonding agent 50 may be introduced through the third opening 26 of the shell 20, so that a portion of the bonding agent 50 is urged outwardly from the gap 27 along the first opening 22 of the shell 20. In doing so, a portion of the bonding agent 50 flows out from the first portion 22 of the shell 20, which after curing, forms a seal bead 52 or an external sealing surface that is external to the bore 30.

The bonding agent may be any suitable material, for example, a silicone polymer, as discussed above.

The tubing 40 and shell 20 combination may then be placed into a second mold with the third opening 26 of the shell 20 facing upward to be cured. Once the cure cycle is complete the second mold is opened, thus resulting in a completed tubing and junction assembly 10. When cured, the bonding agent 50 may function as a sealing plug or joint layer. Thus, the use of the bonding agent 50 and subsequent curing of the bonding agent 50 creates a bonded area that helps to seal the tubing and junction assembly 10.

Prior to introducing the bonding agent 50 through the third opening 26, the interior surface 23 of the shell 20 may be modified, for example, to improve bonding between the tube and the shell. For example, the interior surface 23 of the shell 20 may be modified by applying a primer 55 to the interior surface 23 of the shell 20. The primer 55 may enhance compatibility between the various components, and/or may serve to roughen or etch the surface, as will be understood by those in the art. Alternatively or additionally, the interior surface 23 of the shell 20 may be modified by abrading the interior surface 23 of the shell 20 with an abrasive material. Further still, the outer surface 46 of the tubing 40 may be modified using a plasma etching process, or any other suitable technique.

The method may further include forming additional shells 20, via injection molding or otherwise. For example, the shell 20 may be a first shell 20 and the method may further include forming a second shell 20′ and a third shell 20″. The second shell 20′ and the third shell 20″ may each comprise a respective first opening 22, second opening 24, and third opening 26. The method may further include connecting the first shell 20, the second shell 20′, and the third shell 20″ to one another along their respective second openings 24 with a connector 60.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

While the apparatus and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an,” and “the” include plural referents unless the context clearly dictates otherwise. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower”, etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method of making a tubing and junction assembly for distributing a fluid, the method comprising:
forming a shell, the shell comprising a first opening, a second opening, and a third opening, wherein
the first opening comprises a first end of a bore, and the second opening comprises a second end of the bore, the bore extending from the first opening to the second opening, wherein the bore comprises a first end portion including the first end of the bore, a second end portion including the second end of the bore, and a medial portion extending between the first end portion and the second end portion of the bore, wherein the first end portion, the second end portion, and the medial portion each have a respective length and a respective diameter, the respective diameter of the first end portion, the second end portion, and the medial portion of the bore being substantially uniform along the respective length of the respective first end portion, second end portion, and medial portion of the bore, wherein the diameter of the first end portion is greater than the diameter of the medial portion, and the diameter of the medial portion is greater than the diameter of the second end portion, and
the third opening extends from an exterior surface of the shell to the first end portion of the bore, so that the exterior surface of the shell is in open communication with the first end portion of the bore;
inserting an end of a tubing through the first opening into the bore so that the end of the tubing is seated within the medial portion of the bore, and so that the end of the tubing is adjacent to the second end portion of the bore, wherein the tubing has an outer diameter, an inner diameter, and a lumen defined by the inner diameter, wherein
the inner diameter of the tubing is approximately equal to the diameter of the second end portion of the bore, so that the lumen is in open communication with the second end portion of the bore,
the outer diameter of the tubing is approximately equal to the diameter of the medial portion of the bore, so that the end of the tubing is fittably seated within the medial portion of the bore, and
the outer diameter of the tubing is less than the diameter of the first end portion of the bore, thereby defining a gap between an outer surface of the tubing and an interior surface of the shell along the first end portion of the bore;
introducing a bonding agent through the third opening of the shell into the gap to fill the gap with the bonding agent; and
curing the bonding agent to join the tubing to the shell.

2. The method of claim 1, wherein inserting the end of the tubing through the first opening into the bore so that the end of the tubing is seated within the medial portion of the bore comprises compressively fitting the end of the tubing into the medial portion of the bore.

3. The method of claim 1, further comprising introducing an excess amount of the bonding agent through the third opening of the shell so that a portion of the bonding agent is urged outwardly from the gap along the first opening of the shell.

4. The method of claim 1, further comprising modifying the interior surface of the shell prior to introducing the bonding agent through the third opening.

5. The method of claim 4, wherein modifying the interior surface of the shell comprises applying a primer to the interior surface of the shell.

6. The method of claim 4, wherein modifying the interior surface of the shell comprises abrading the interior surface of the shell with an abrasive material.

7. The method of claim 1, wherein
the shell is a first shell and
the method further comprises
forming a second shell and a third shell, wherein the second shell and the third shell each comprise a respective first opening, second opening, and third opening, and
connecting the first shell the second shell, and the third shell to one another along their respective second openings with a connector.

8. A tubing and junction assembly for distributing a fluid, comprising:
a shell comprising a first opening, a second opening, and a third opening, wherein
the first opening comprises a first end of a bore, and the second opening comprises a second end of the bore, the bore extending from the first opening to the second opening, wherein the bore comprises a first end portion including the first end of the bore, a second end portion including the second end of the bore, and a medial portion extending between the first end portion and the second end portion of the bore, wherein the first end portion, second end portion, and medial portion each have a respective length and a respective diameter, the respective diameter of the first end portion, second end portion, and medial portion of the bore being substantially uniform along the respective length of the respective first end portion, second end portion, and medial portion of the bore, wherein the diameter of the first end portion is greater than the diameter of the medial portion, and the diameter of the medial portion is greater than the diameter of the second end portion, and
the third opening extends from an exterior surface of the shell to the first end portion of the bore, so that the exterior surface of the shell is in open communication with the first end portion of the bore;
a tubing comprising an end, an outer diameter, an inner diameter, and a lumen defined by the inner diameter, wherein the end of the tubing is positioned within the medial portion of the bore, such that the end of the tubing is adjacent to the second end portion of the bore, wherein
the inner diameter of the tubing is approximately equal to the diameter of the second end portion of the bore, so that the lumen is in open communication with the second end portion of the bore,
the outer diameter of the tubing is approximately equal to the diameter of the medial portion of the bore, so that the end of the tubing is fittably seated within the medial portion of the bore, and
the outer diameter of the tubing is less than the diameter of the first end portion of the bore; and
a cured bonding agent positioned between an outer surface of the tubing and an interior surface of the shell along the first end portion of the bore.

9. The tubing and junction assembly of claim 8, wherein the cured bonding agent extends into the third opening of the shell.

10. The tubing and junction assembly of claim 8, further comprising a seal bead extending around the first opening of the shell.

11. The tubing and junction assembly of claim 8, further comprising a primer layer between the interior surface of the shell and the cured bonding agent.

12. The tubing and junction assembly of claim 8, wherein the interior surface of the shell comprises an abraded surface.

13. The tubing and junction assembly of claim 8, wherein the cured bonding agent comprises a silicone polymer.

14. The tubing and junction assembly of claim 8, wherein the medial portion of the bore is at least one of shaped and sized to compressively receive the tubing.

15. The tubing and junction assembly of claim 8, wherein the bore further comprises a flow groove between the medial portion and the first end portion, the flow groove having a respective length and a respective diameter, the respective diameter of the flow groove being greater than the diameter of the first end portion and the diameter of the medial portion.

16. The tubing and junction assembly of claim 8, wherein the cured bonding agent has a color that differs from a respective color of the tubing and shell.

17. The tubing and junction assembly of claim 8, wherein the shell further comprises a fourth opening, wherein the fourth opening extends from an exterior surface of the shell to the first end portion of the bore, so that the exterior surface of the shell is in open communication with the first end portion of the bore.

18. The tubing and junction assembly of claim 8, wherein the shell has a linear shape.

19. The tubing and junction assembly of claim 8, wherein
the shell is a first shell and
the tubing and junction assembly further comprises
a second shell and a third shell, the second shell and the third shell each comprising a respective first opening, second opening, and third opening, and
a connector connecting the first shell the second shell, and the third shell to one another along their respective second openings.

20. The tubing and junction assembly of claim 19, wherein the assembly has a shape selected from the group consisting of a T-shape, a Y-shape, and an X-shape.
